(19) United States
(12) Patent Application Publication
(10) Pub. No.: US 2002/0162436 A1
(43) Pub. Date: Nov. 7, 2002

(54) Apparatus and method for handling and cutting a flexible material wrapped around a load

(76) Inventors: Yanick Marois, Fleurimont (CA); Glen Ditchburn, Ayer's Cliff (CA); Guy Lopes, Sherbrooke (CA); Sylvain Samson, Ayer's Cliff (CA)

Correspondence Address: MYERS BIGEL SIBLEY & SAJOVEC, PO BOX 37428, RALEIGH, NC, 27627, US

(21) Appl. No.: 10/119,796

(22) Filed: Apr. 10, 2002

Related U.S. Application Data
(60) Provisional application No. 60/282,908, filed on Apr. 11, 2001.

(51) Int. Cl. B26D 1/00; B26D 5/02

(52) U.S. Cl. 83/13; 83/523

(57) ABSTRACT

Apparatus and method for handling and cutting a flexible material that is wrapped around a load by means of a delivering device. The apparatus includes a clamp and cutter assembly having a trigger activated mechanism, and a trigger and roping assembly. The apparatus also includes a moving device for moving the trigger and roping assembly between active and retracted positions. In use, as the trigger and roping assembly is moved into its active position, the trigger engages with the trigger activated mechanism to move the clamp and cutter assembly to its open position, while the roper turns a portion of flexible material into a rope. As the trigger and roping assembly is retracted from its active position, the trigger disengages with the trigger activated mechanism to move the clamp and the cutter assembly in its closed position, thereby cutting the rope and holding a free end thereof.

### RELATED APPLICATION

This application claims priority from United States Provisional application Ser. No. 60/282,908, filed Apr. 11, 2001, the disclosure of which is incorporated by reference herein in its entirety.

### FIELD OF THE INVENTION

The present invention relates to an apparatus and method for handling and cutting a flexible material that is wrapped around a load.

### BACKGROUND

In the industry, it is of common practice to use two types of load wrapping machines, which are respectively defined as automatic and semi-automatic. In the case of automatic load wrapping machines, these can carry out a series of cycle start and end operations without the direct action of operators. In the case of semi-automatic load wrapping machines, operators are required in order to carry out certain operations. As is known in the industry, semi-automatic load wrapping machines are typically less expensive than the automatic machines, but have the drawback of being less efficient because of the operator's involvement.

The way a semi-automatic machine works can be defined by the following steps:

a) an operator places a load to be wrapped on either a rotary or a fixed platform;

b) the operator attaches a leading end of a film web to the load to be wrapped;

c) the operator presses a start button on the machine so that a relative rotation between the load and a film delivering device is carried out, and waits until the wrap cycle is completed;

d) the operator cuts the film web between the load being wrapped and the film delivering device;

e) the operator removes the wrapped product from the platform.

To wrap the next load, the operator has to repeat all the above steps, which is disadvantageous because of lack of efficiency and productivity for example.

There is therefore a need in the industry to convert semi-automatic load wrapping machines into more efficient automatic load wrapping machines.

An object of the invention is to therefore provide an apparatus and a method that satisfy the above-mentioned need and can thus be used to convert a semiautomatic load wrapping machine into an automatic load wrapping machine.

Known in the art, there is U.S. Pat. No. 6,164,047 (ROSSI) which discloses a device and method for automatically cutting and re-attaching a film for wrapping a product. The product to be wrapped is first placed on a rotating platform and is wrapped by means of a vertically moving reel that provides the film. A rod provided with a roller on one of its end is pivoted between a raised inoperative position and a lowered operating position where a portion of the film is reduced. A gripper and cutting unit is located on the rotating platform and is used for cutting the reduced portion of the film during rotation of the platform. A cam with a pin located near the platform is used to intercept the edge of the film already cut to re-attach the film to a new pack to be wrapped

Also known in the art, there are the following U.S. patents which describe different apparatuses and methods for wrapping loads: U.S. Pat. No. 4,204,377 (LANCASTER); U.S. Pat. No. 4,300,326 (LANCASTER) U.S. Pat. No. 5,528,881 (CAPPI); U.S. Pat. No. 6,185,900 (MARTIN); U.S. Pat. No. 6,189,291 (MARTIN); U.S. Pat. No. 6,269,610 (LANCASTER) and U.S. patent application Ser. No. 2001/0015050 (LANCASTER).

A drawback with apparatus or methods of the prior art is that none of them is concerned with an apparatus or methods for handling and cutting flexible material wrapped around an article in a simple and efficient manner.

Another object of the present invention is therefore to provide a method and an apparatus for handling and cutting a flexible material wrapped around a load in a manner that is simpler and more efficient than those provided in prior art.

### SUMMARY

According to the present invention, there is provided an apparatus for handling and cutting a flexible material wrapped around a load by means of a delivering device, comprising:

a) a clamp and cutter assembly having:

i) a controllable clamp movable between open and closed positions, the clamp having a trigger activated mechanism for moving the clamp between its open and closed positions, and

ii) a controllable cutter movable between open and closed positions, the cutter having a trigger activated mechanism for moving the cutter between its open and closed positions;

b) a trigger and roping assembly having:

i) a trigger for triggering the trigger activated mechanisms of the controllable clamp and cutter, and

ii) a roper for roping a portion of the flexible material; and

c) a moving device connected to the trigger and roping assembly for moving the trigger and roping assembly between a retracted position and an active position where, as the trigger and roping assembly is moved into its active position, the trigger engages with the trigger activated mechanisms to move the clamp and the cutter to their open position, and the roper engages with a portion of the flexible material extending from the load to the delivering device to turn said portion of flexible material into a rope, and, as the trigger and roping assembly is retracted from its active position, the trigger disengages with the trigger activated mechanisms to move the clamp and the cutter in their closed position, thereby cutting the rope and holding a free end thereof extending from the delivering device by means of the clamp.

According to another aspect of the present invention, there is provided an apparatus for handling and cutting a flexible material wrapped around a load by means of a delivering device, comprising:

a) a clamp and cutter assembly having:

i) a controllable clamp movable between open and closed positions, the clamp having a trigger activated mechanism for moving the clamp between its open and closed positions, and

ii) a controllable cutter movable between open and closed positions, the cutter having a trigger activated mechanism for moving the cutter between its open and closed positions;

b) a trigger and roping assembly having:

i) a trigger for triggering the trigger activated mechanisms of the controllable clamp and cutter, and

ii) a roper for roping a portion of the flexible material; and

c) a moving device connected to the trigger and roping assembly for moving the trigger and roping assembly between a retracted position and an active position where, as the trigger and roping assembly is moved into its active position, the trigger engages with the trigger activated mechanisms to move the clamp and the cutter to their open position, and the roper engages with a portion of the flexible material extending from the load to the delivering device to turn said portion of flexible material into a rope, and, as the trigger and roping assembly is retracted from its active position, the trigger disengages with the trigger activated mechanisms to move the clamp and the cutter in their closed position, thereby cutting the rope and holding a free end thereof extending from the delivering device by means of the clamp;

wherein the clamp has movable and fixed jaws and the cutter has movable and fixed blades, the movable blade being adjacent and solid with the movable jaw, the fixed jaw being adjacent to the fixed blade, and wherein the moving device comprises a frame, a first arm having a first end pivotally connected to the frame, a second arm having a first end knuckle jointed to a second end of the first arm and a second end for carrying the trigger and roping assembly, and a motor for moving the first and second arms between active and retracted positions.

According to yet another aspect of the present invention, there is provided a method for handling and cutting a flexible material wrapped around a load by means of a delivering device, comprising the steps of:

a) moving a trigger and roping assembly from a retracted position to an active position;

b) engaging a trigger of the trigger and roping assembly with a trigger activated means of a clamp and cutter assembly as the trigger and roping assembly is moved into its active position;

c) moving the clamp and the cutter assembly from a closed position to an open position in response to the trigger engaging the trigger activated means;

d) engaging a roper of the trigger and roping assembly with a portion of the flexible material extending from the load to the delivering device to turn said portion of flexible material into a rope, as the trigger and roping assembly is moved into its active position;

e) moving the trigger and roping assembly from the active position to the retracted position;

f) disengaging the trigger from the trigger activated means as the trigger and roping assembly is retracted from its active position; and

g) moving the clamp and cutter assembly from the open position to the closed position in response to the trigger disengaging from the trigger activated means, thereby cutting the rope and holding a free end thereof extending from the delivering device by means of the clamp and cutter assembly.

The objects, advantages and other features of the present invention will become more apparent upon reading of the following non-restrictive description of preferred embodiments thereof, given for the purpose of exemplification only with reference to the accompanying drawings, in which like numbers refer to like elements.

### BRIEF DESCRIPTION OF THE DRAWINGS

FIG. 1 is a perspective view of an apparatus for handling and cutting a flexible material, according to a preferred embodiment of the present invention;

FIG. 2 is a partial side view of the apparatus for handling and cutting a flexible material taken along lines II-II of FIG. 1;

FIG. 3 is a perspective view of an apparatus for handling and cutting a flexible material according to a preferred embodiment of the present invention, the apparatus being mounted alongside a first type of flexible material delivering device;

FIG. 4 is a perspective view of an apparatus for handling and cutting a flexible material according to a preferred embodiment of the present invention, the apparatus being mounted alongside a second type of flexible material delivering device;

FIG. 5 is a perspective view of an apparatus for handling and cutting a flexible material according to a preferred embodiment of the present invention, the apparatus being mounted alongside a third type of flexible material delivering device;

FIG. 6 is a perspective view of an apparatus for handling and cutting a flexible material to be wrapped around a load according to a preferred embodiment of the present invention, the apparatus being mounted alongside the first type of flexible material delivering device with a trigger and roping assembly of the apparatus positioned in a retracted position;

FIG. 7 is a partial perspective view of the apparatus for handling and cutting the flexible material that is shown in FIG. 6;

FIG. 8 is a partial perspective view of the apparatus for handling and cutting the flexible material that is shown in FIG. 6 once the load has been wrapped with a flexible material by means of the delivering device;

FIG. 9 is a partial perspective view of the apparatus for handling and cutting the flexible material that is shown in FIG. 8 where the trigger and roping assembly thereof is positioned between its retracted and active positions according to a preferred embodiment of the present invention.

FIGS. 10A to 10E are partial perspective views of a trigger and roping assembly engaging with a clamp and cutter assembly in different engagement positions according to a preferred embodiment of the present invention;

FIG. 11 is a partial perspective view of the apparatus for handling and cutting the flexible material that is shown in FIG. 9 where the trigger and roping assembly thereof is positioned in its active position, according to a preferred embodiment of the present invention.

FIGS. 12 and 13 are partial perspective views of the apparatus for handling and cutting the flexible material that is shown in FIG. 9 where the trigger and roping assembly thereof is positioned in its active position and where a roper of the trigger and roping assembly has turned a portion of the flexible material into a rope;

FIG. 14 is a partial perspective view of the apparatus for handling and cutting the flexible material that is shown in FIG. 9 where the trigger and roping assembly is moved from its active position to its retracted position and where the clamp and cutter assembly has cut the rope and holds a free end of the rope, according to a preferred embodiment of the present invention.

FIG. 15 is partial perspective view of the apparatus for handling and cutting the flexible material that is shown in FIG. 14 as the trigger and roping assembly is further moved to its retracted position.

### DETAILED DESCRIPTION OF THE PREFERRED EMBODIMENTS

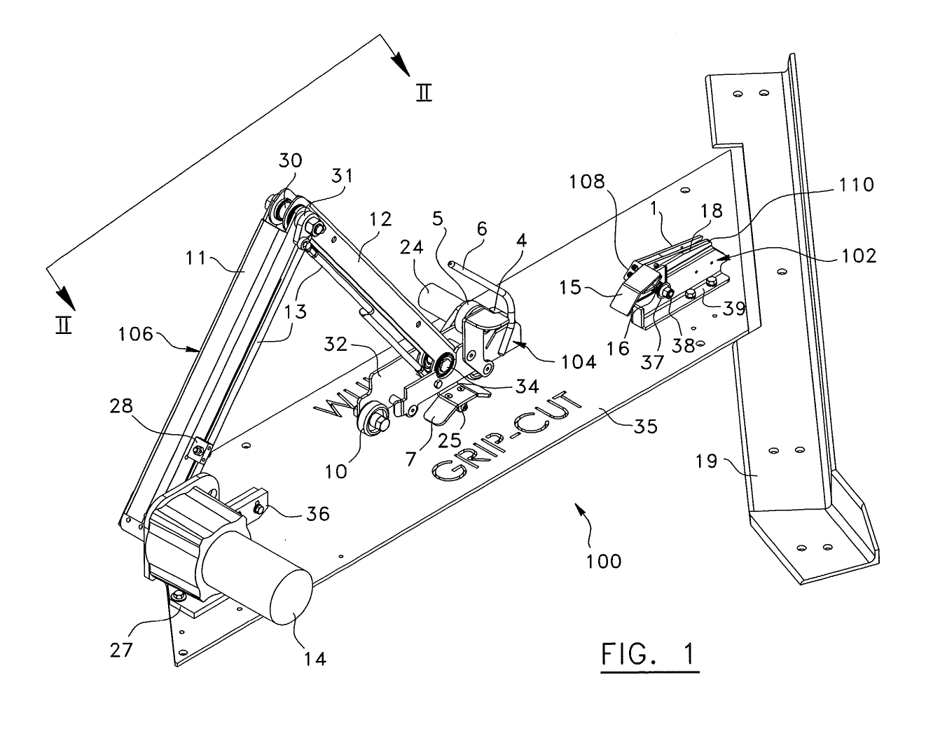

Referring to FIGS. 1 to 15, there are shown preferred embodiments of an apparatus according to the present invention within the environment in which it operates.

The apparatus 100 is for handling and cutting a flexible material 20 that is wrapped around a load 57 by means of a delivering device 101. The flexible material 20 may be a plastic film web that can be provided by any suitable delivering device 101.

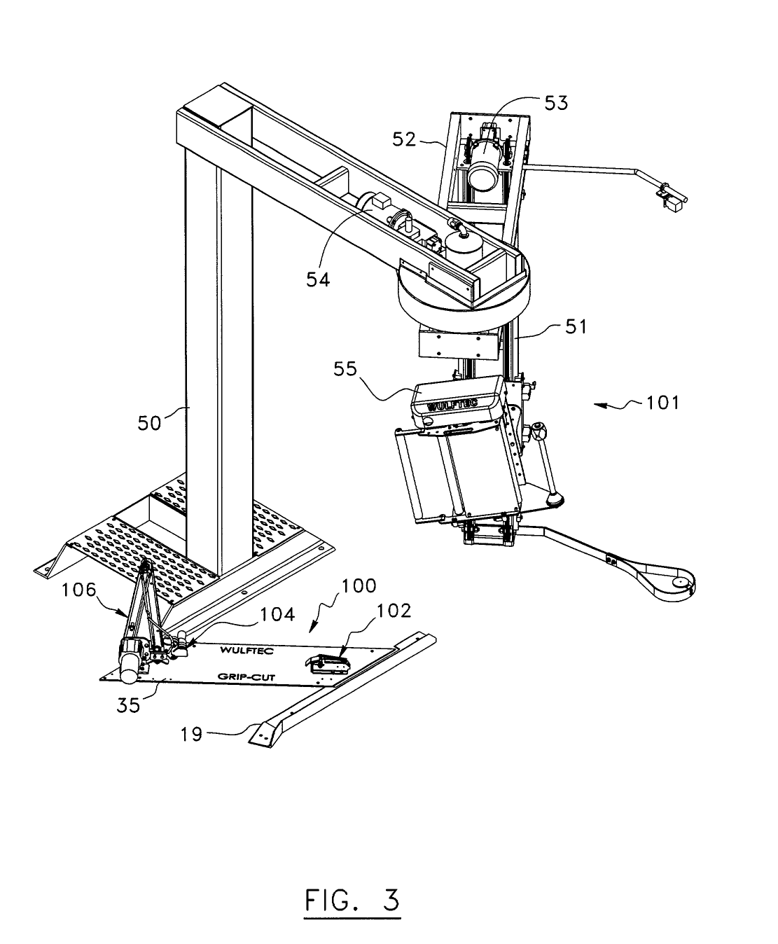

Referring to FIGS. 3, 4 and 5, there are show three types of embodiments of delivering devices 101 that may be used with the apparatus 100. Of course, other delivering devices differing from those illustrated may be used with the apparatus of the present invention as will be understood by those skilled in the art.

Referring to FIG. 3, the first type of delivering device 101 consists of a support frame 50 made of a vertical column and a horizontal beam. The horizontal beam contains a rotation motor 54 used for rotating a rotatable horizontal arm 52 which is mounted under the horizontal beam. The rotatable horizontal arm 52 contains an elevating motor 53 used for vertically moving a carriage 55 that holds a roll of flexible material to be wrapped around a load. The carriage 55 is slidably mounted on a vertical boom structure 51, which is connected at one end of the rotatable horizontal arm 52.

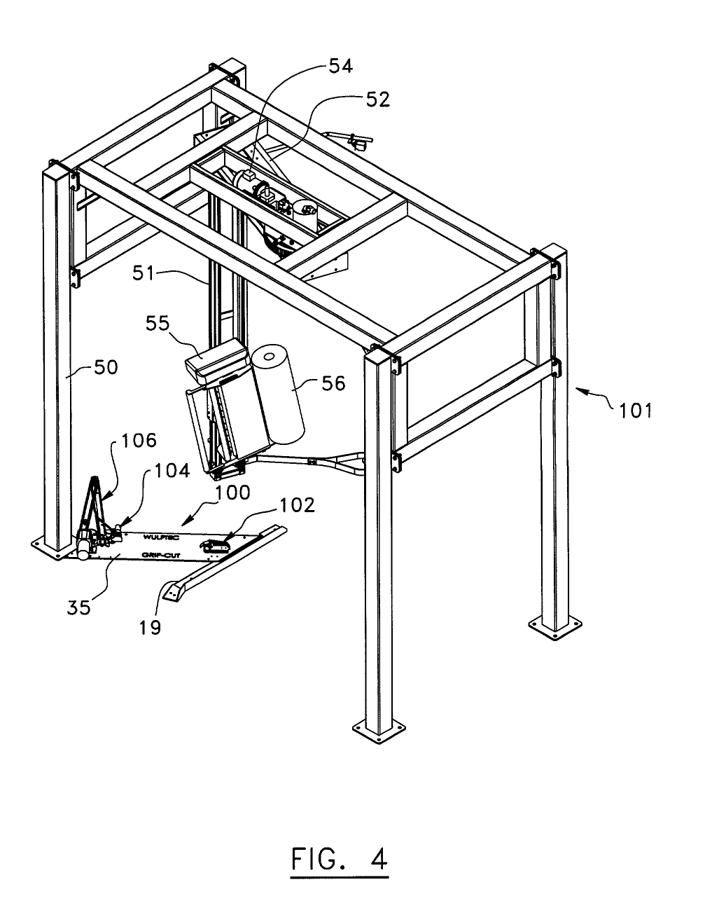

Referring to FIG. 4, the second type of delivering device 101 is similar to the first type. The second type of delivering device 101 also consists of a support frame 50, but in this case it has four legs connected together by horizontal bars. The support frame 50 contains the same rotation motor 54 used for rotating the rotatable horizontal arm 52, which in turn has the same elevating motor (not shown) for vertically moving the carriage 55 that holds the roll of flexible material 56 to be wrapped around a load. The carriage 55 is also slidably mounted on the vertical boom structure 51, which is connected at one end of the rotatable horizontal arm 52.

In order to wrap a load with both of the above-described delivering devices, the roll of flexible material is moved up and down while it is simultaneously rotated around a load.

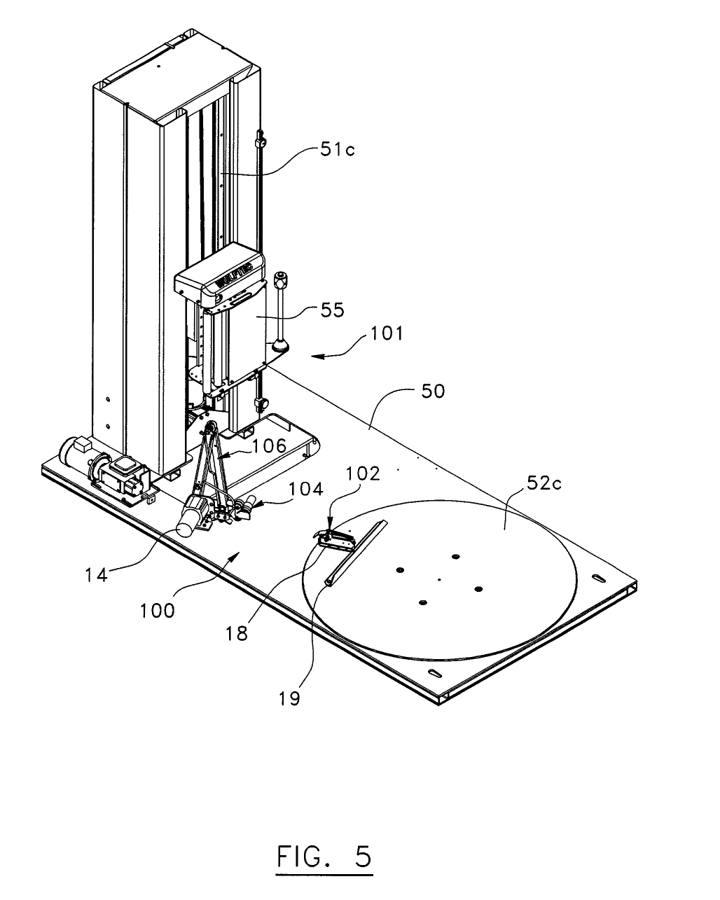

Referring to FIG. 5, the third type of delivering device includes a turntable 52c mounted on a support frame 50. The delivering device has a fixed vertical structure 51c onto which a carriage 55 can slidably move up and down. In order to wrap a load with this type of delivering device, the roll is only moved vertically up and down while the load is simultaneously rotated by means of the turntable 52c.

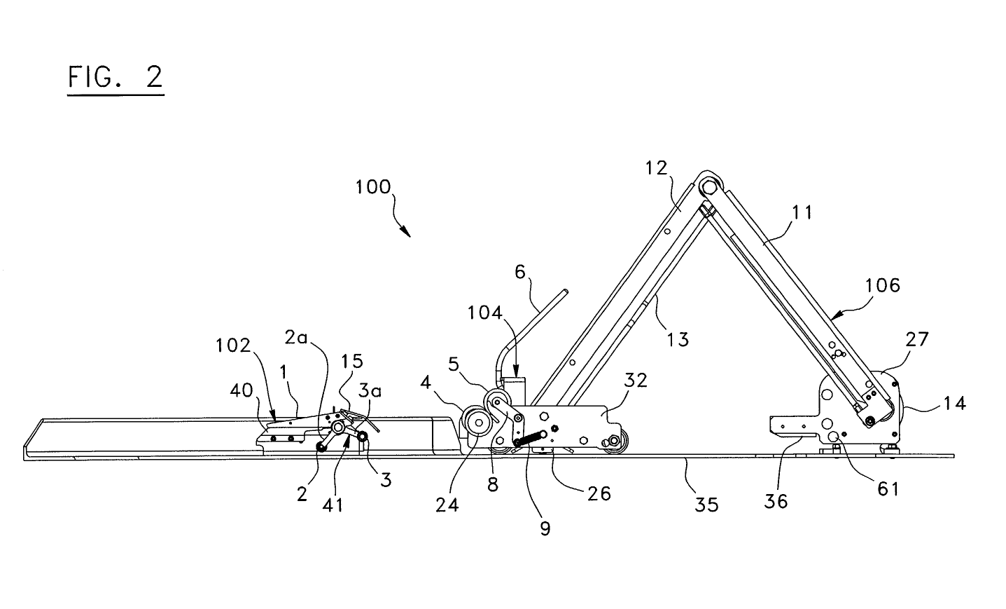

Referring to FIGS. 1 and 2, the apparatus 100 according to a preferred embodiment of the present invention is formed of a clamp and cutter assembly 102, a trigger and roping assembly 104, and a moving device 106.

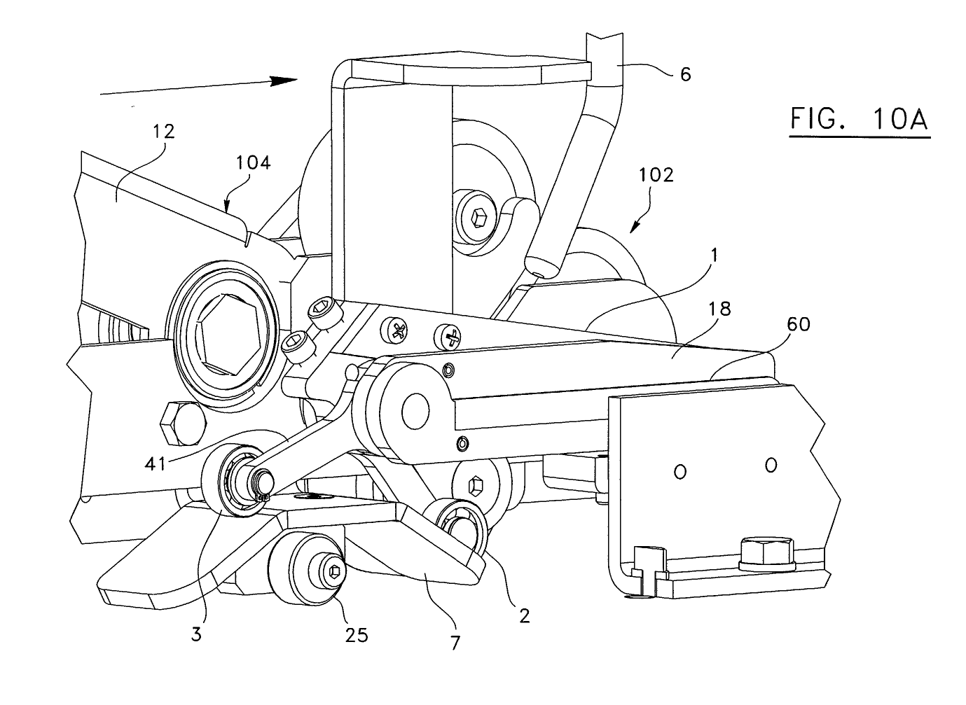

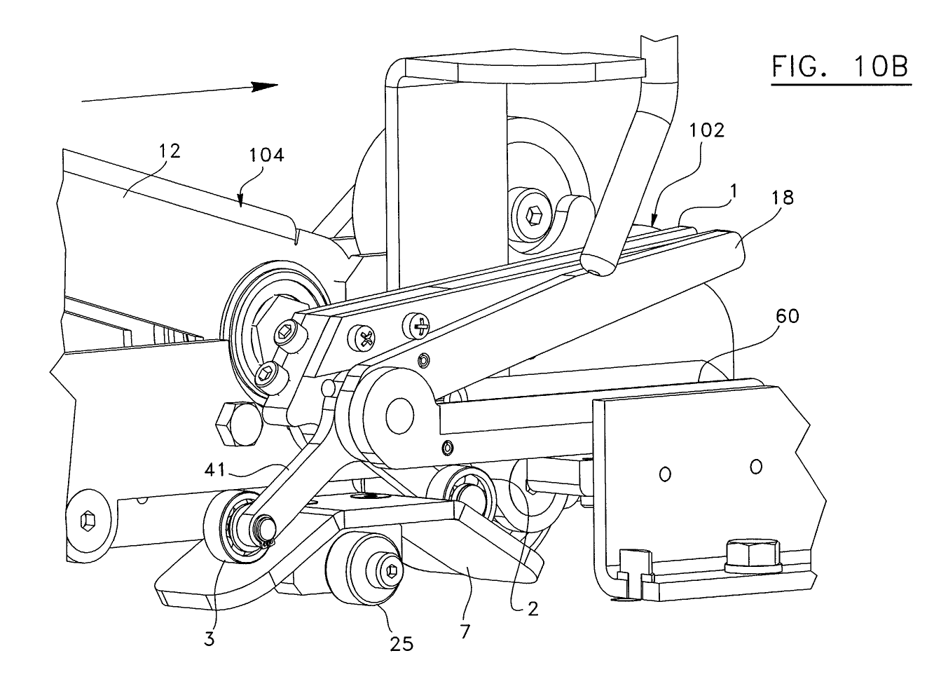

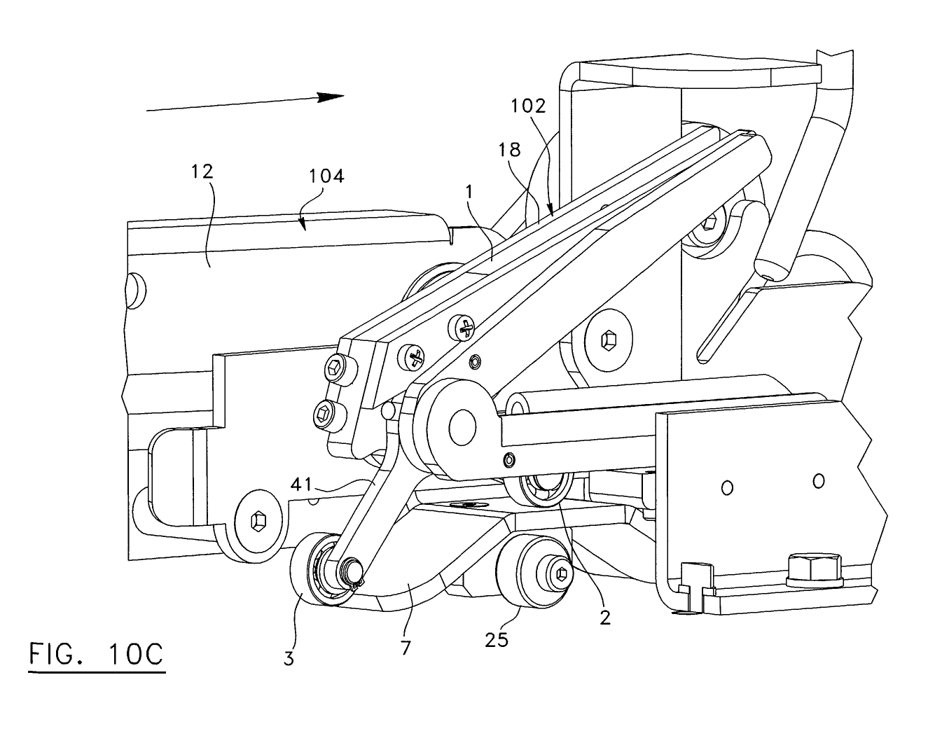

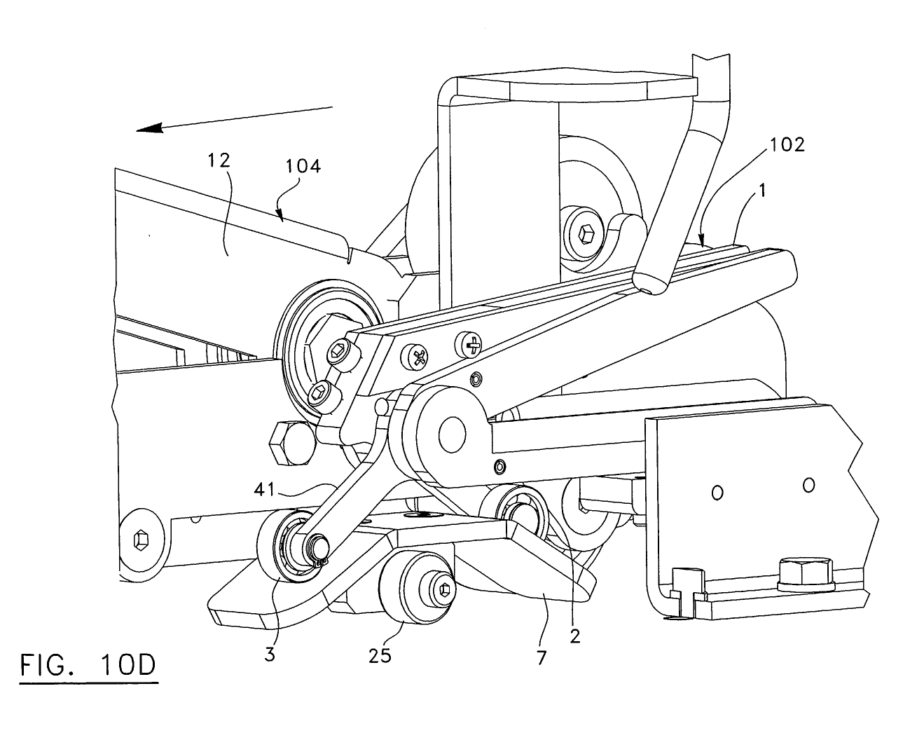

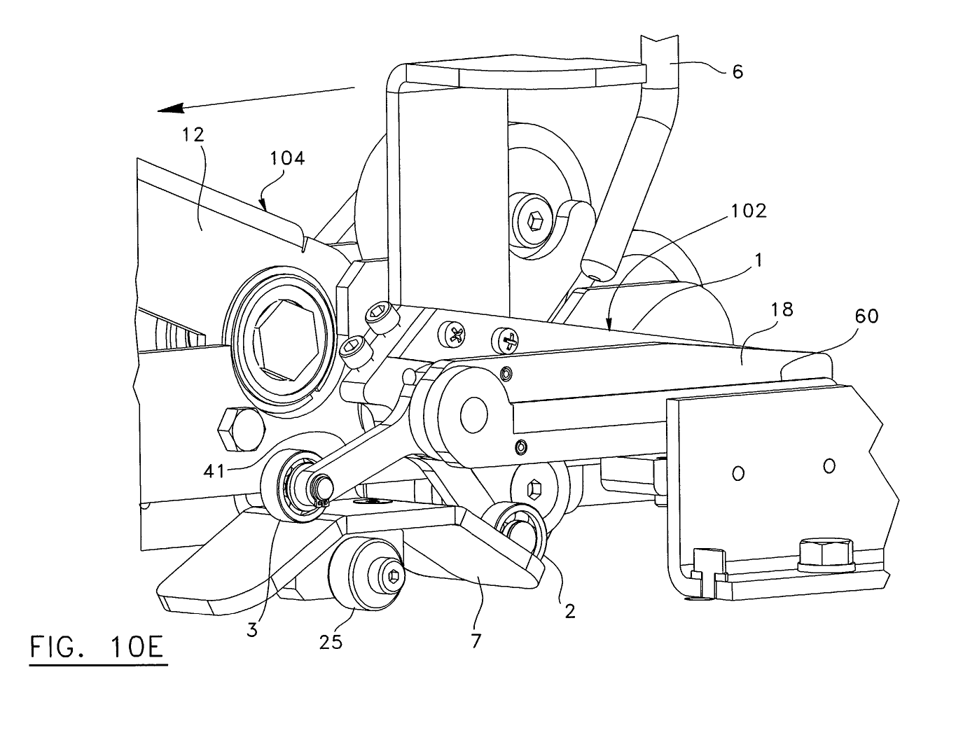

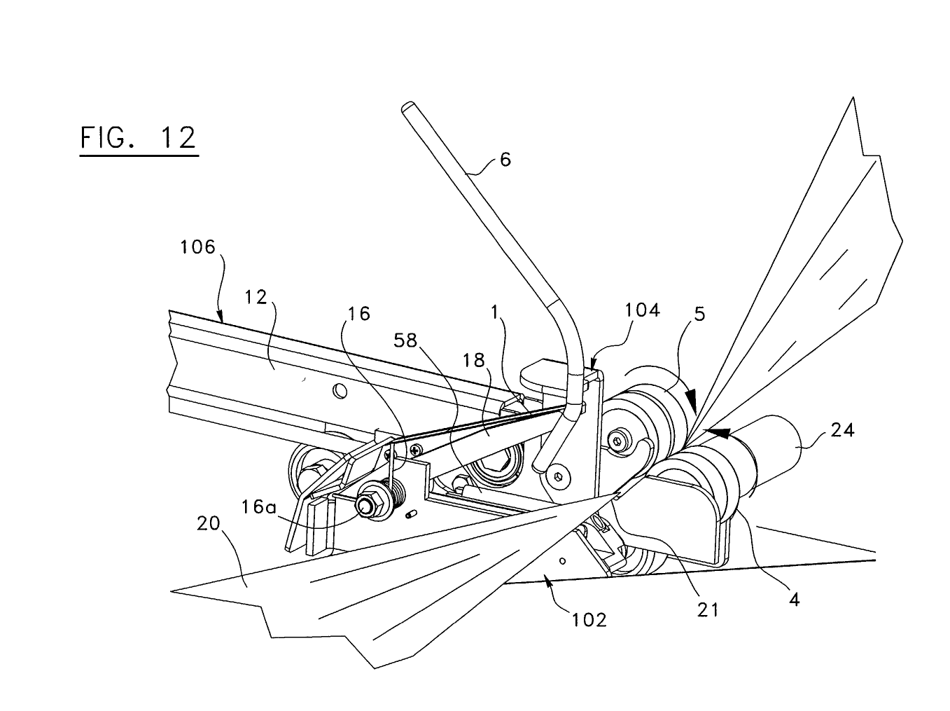

The clamp and cutter assembly 102 includes a controllable clamp 108 that is movable between open and closed positions. The clamp 108 preferably consists of a movable upper jaw 1 and a fixed lower jaw 40 covered with a silicone tube 58 (shown in FIG. 12), which cooperates with the movable jaw 1 upon a clamping motion thereof. The clamp 108 has a trigger activated mechanism for moving the clamp 108 between its open and closed positions. The clamp and cutter assembly 102 also has a controllable cutter 110 that is also movable between open and closed positions. The cutter 110 preferably consists of a movable upper blade 18 and a fixed lower blade 60, with the movable blade 18 being adjacent and solid with the movable jaw 1 and the fixed jaw 40 being adjacent to the fixed blade 60. The cutter 110 also has a trigger activated mechanism for moving the cutter 110 between its open and closed positions. As is illustrated throughout the figures, both of the trigger activated mechanisms are preferably embodied by single trigger activated mechanism 41. The triggered activated mechanism 41 preferably has a resilient device urging the clamp 108 and cutter 110 in their closed position. Such resilient device may consist of a coiled spring 16 mounted on a pivot point 16a of the clamp and cutter assembly 102 as shown in FIG. 12 for example. Preferably, as shown in FIG. 2, and FIGS. 10A to 10E, the single trigger activated mechanism 41 comprises a two-legged member pivotally mounted on the pivot point 16a of the clamp and cutter assembly 102. The two-legged member has a front extending leg 3a provided with a wheel 3 and rear extending leg 2a also provided with a wheel 2. The two-legged member is biased by the coiled spring 16 resulting in the rear extending leg 2a being urged downward while the front extending leg 3a is urged upwards. The same coiled spring 16 preferably urges the clamp and cutter assembly 102 in its normally closed position.

Referring back to FIG. 1, a preferred embodiment of the clamp and cutter assembly 102 is illustrated with numeral 15 corresponding to a deflector, numeral 37 to a clamp washer, numeral 38 to a spring washer, and numeral 39 to a clamp base. A load stopper 19 may also be used for preventing the load to be pushed onto and possibly damaging the apparatus 100.

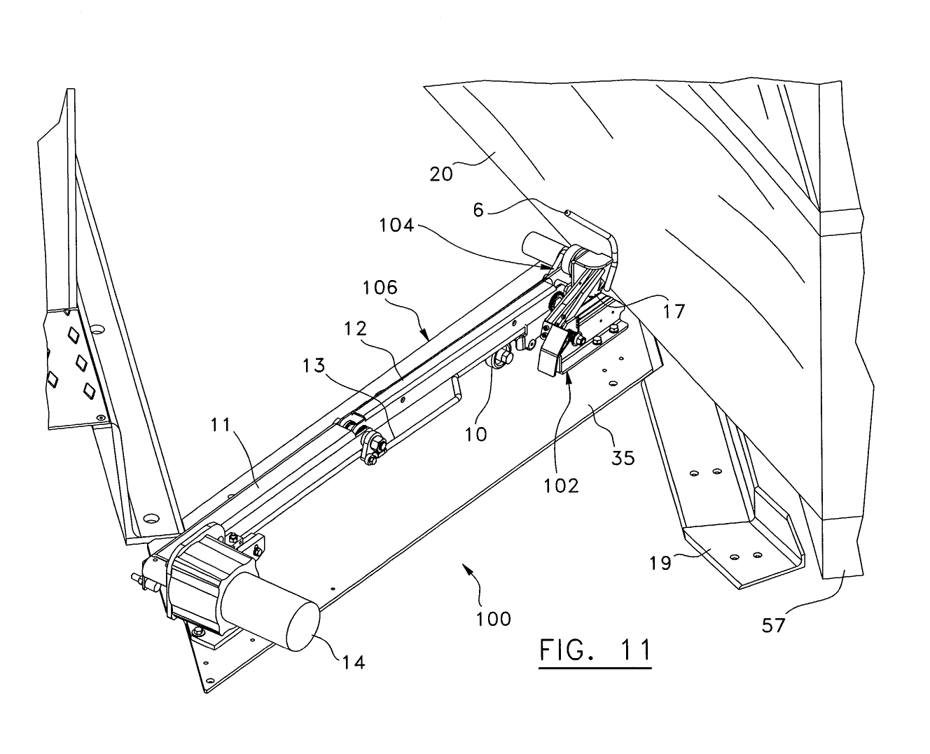

The trigger and roping assembly 104 includes a trigger 7 for triggering the trigger activated mechanisms of the controllable clamp 108 and cutter 110. The trigger and roping assembly 104 also has a roper for roping a portion of the flexible material 20 as shown for example in FIGS. 11 to 13. The roper preferably consists of a drive roping wheel 4, a motor 24 connected to the drive roping wheel 4, and an idler wheel 5 facing the drive roping wheel 4. A curved guide 6 is preferably used for guiding the flexible material 20 toward the roper. The trigger 7 preferably has rising, flat-top and descending ramps engaging with the wheels 2 and 3 of the two-legged member to move the clamp 1 and cutter 18 between the open and closed positions. The trigger 7 may have other suitable shapes in order to achieve the same result, such as a continuous convex shape for example. As illustrated, the trigger may be supported by a wheel 25 mounted on a support wheel member 26.

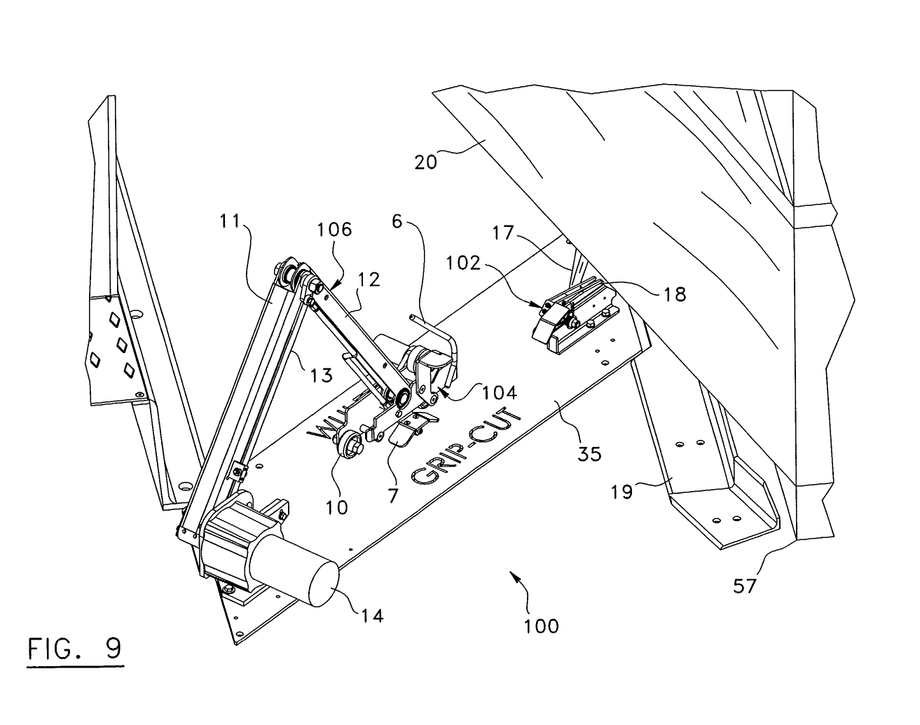

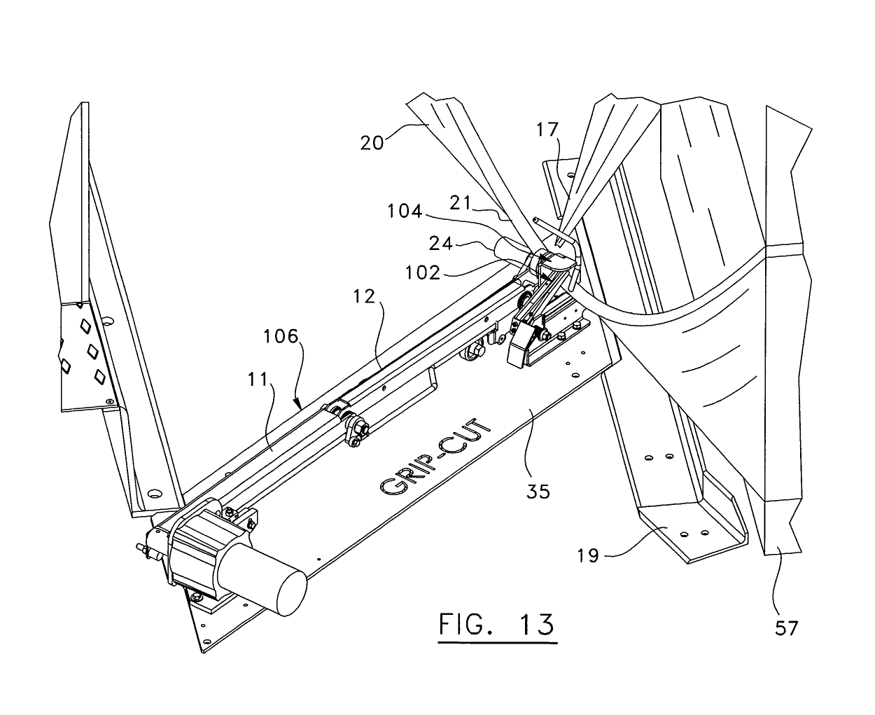

The moving device 106 is connected to the trigger and roping assembly 104 for moving the trigger and roping assembly 104 between a retracted position, as shown for example in FIGS. 3 to 8, and an active position, as shown for example in FIGS. 11 to 13. As the trigger and roping assembly 104 is moved into its active position, as shown for example in FIG. 9, the trigger 7 engages with the trigger activated mechanisms 41 to move the clamp 108 and the cutter 110 to their open position, as shown in FIGS. 10A to 10C. In the active position, the roper engages with a portion of the flexible material 20 extending from the load 57 to the delivering device 101 so as to turn such portion of flexible material 20 into a rope 21, as shown for example in FIGS. 12 and 13. Then, as the trigger and roping assembly 104 is retracted from its active position, the trigger 7 disengages with the trigger activated mechanism 41 to move the clamp 108 and the cutter 110 in their closed position, as shown for example in FIGS. 10D and 10E. Thereby, the clamp and cutter assembly 102 cuts the rope 21 by means of the cutter 110 and holds a free end of the rope 21 by means of the clamp 108. The free end of the rope 21 held by the clamp 108 extends from the delivering device 101.

Preferably, the moving device 106 includes a frame 27 and a first arm 11 having a first end pivotally connected to the frame 27. A second arm 12 has a first end knuckle jointed to a second end of the first arm 11. A second end of the second arm 12 pushes and pulls on a carrying member 32 provided with wheels 10 for carrying the trigger and roping assembly 104. A motor 14 mounted on the frame 27 is used for moving the first and second arms 11, 12 between the active and retracted positions. The second arm 12 is connected to the carrying member through a pivot pin 34.

As shown for example in FIGS. 1 to 4, the frame 27 of the moving device 106 and the clamp and cutter assembly 102 are both preferably mounted on a plate 35 at a predetermined distance from each other, which can be adjusted according to the particular design parameters that are chosen. The mounting of the moving device 106 and clamp and cutter assembly 102 on the plate 35 is particularly applicable to the first two types of delivering devices, which are illustrated in FIGS. 3 and 4.

Referring to FIG. 5, there is shown another use of the apparatus 100 according to a preferred embodiment of the present invention where the clamp and cutter assembly 102 is mounted on the rotatable turntable 52c of the delivering device 101. As illustrated, the moving device 106 is positioned at a predetermined distance from the home position of the clamp and cutter assembly 102 mounted on the turntable 52c. When wrapping the load by means of the delivering device 101, the clamp and cutter assembly 102 is rotated by the turntable 52c and makes at least a complete revolution before returning to its home position.

According to the present invention, there is also provided a method for handling and cutting the flexible material 20 wrapped around a load 57 by means of a delivering device 101. The method, which is described with reference to the Figures includes the following steps:

a) moving the trigger and roping assembly 104 from a retracted position, as shown in FIG. 9, to an active position as shown in FIG. 11;

b) engaging a trigger 7 of the trigger and roping assembly 104 with a trigger activated mechanism 41 of a clamp and cutter assembly 102 as the trigger and roping assembly 104 is moved into its active position as shown in FIG. 10A;

c) moving the clamp and the cutter assembly 102 from a closed position, as shown in FIG. 10A, to an open position, as shown in FIGS. 10B and 10C, in response to the trigger 7 engaging the trigger activated mechanism 41;

d) engaging a roper of the trigger and roping assembly 104 with a portion of the flexible material 20 extending from the load 57 to the delivering device 101, as shown in FIG. 12, to turn the portion of flexible material 20 into a rope 21, as the trigger and roping assembly 104 is moved into its active position;

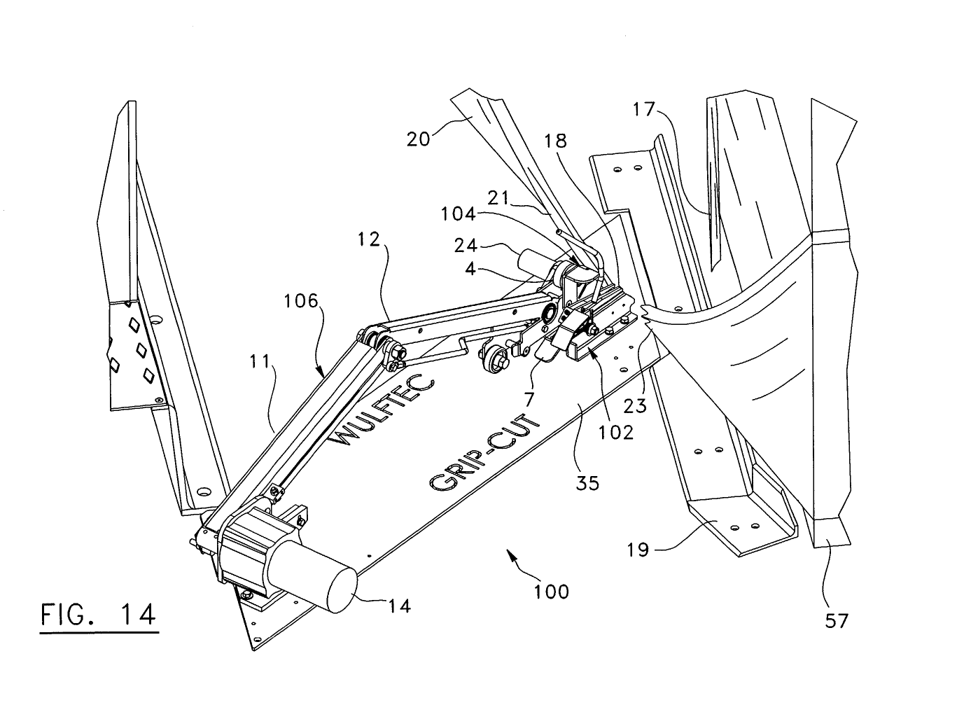

e) moving the trigger and roping assembly 104 from the active position to the retracted position as shown in FIG. 14;

f) disengaging the trigger 7 from the trigger activated mechanism 41 as the trigger and roping assembly 104 is retracted from its active position as shown in FIGS. 10D and 10E; and

g) moving the clamp and cutter assembly 102 from the open position, as shown in FIG. 10D, to the closed position, as shown in FIG. 10E, in response to the trigger 7 disengaging from the trigger activated mechanism 41, thereby cutting the rope 21 and holding a free end thereof extending from the delivering device 101 by means of the clamp and cutter assembly 102.

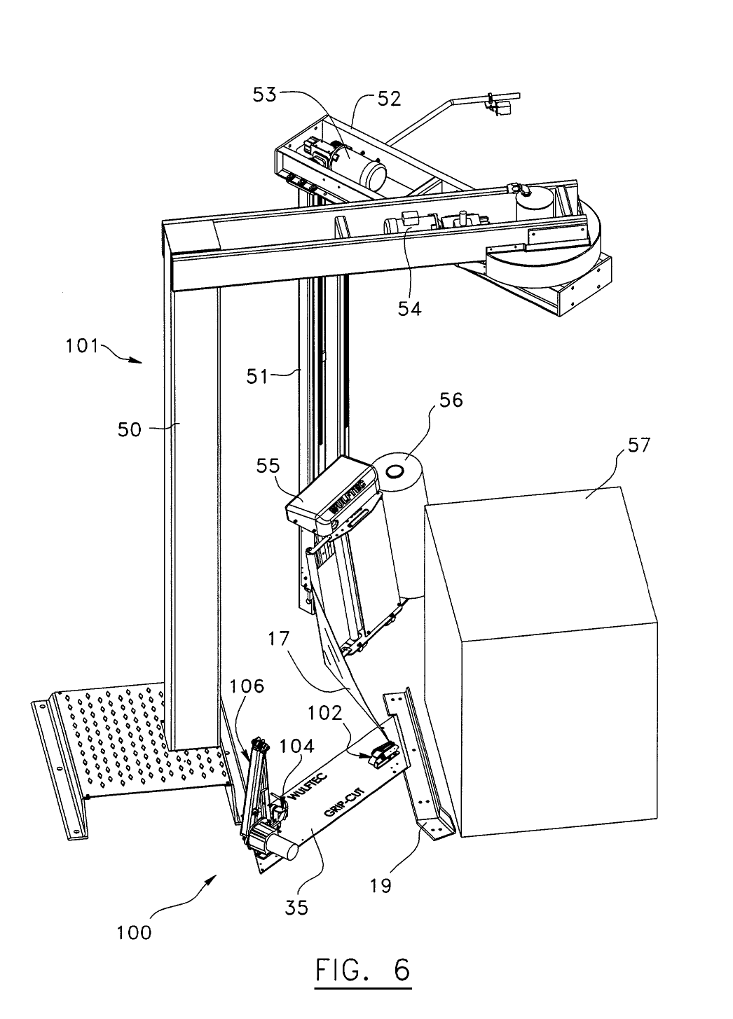

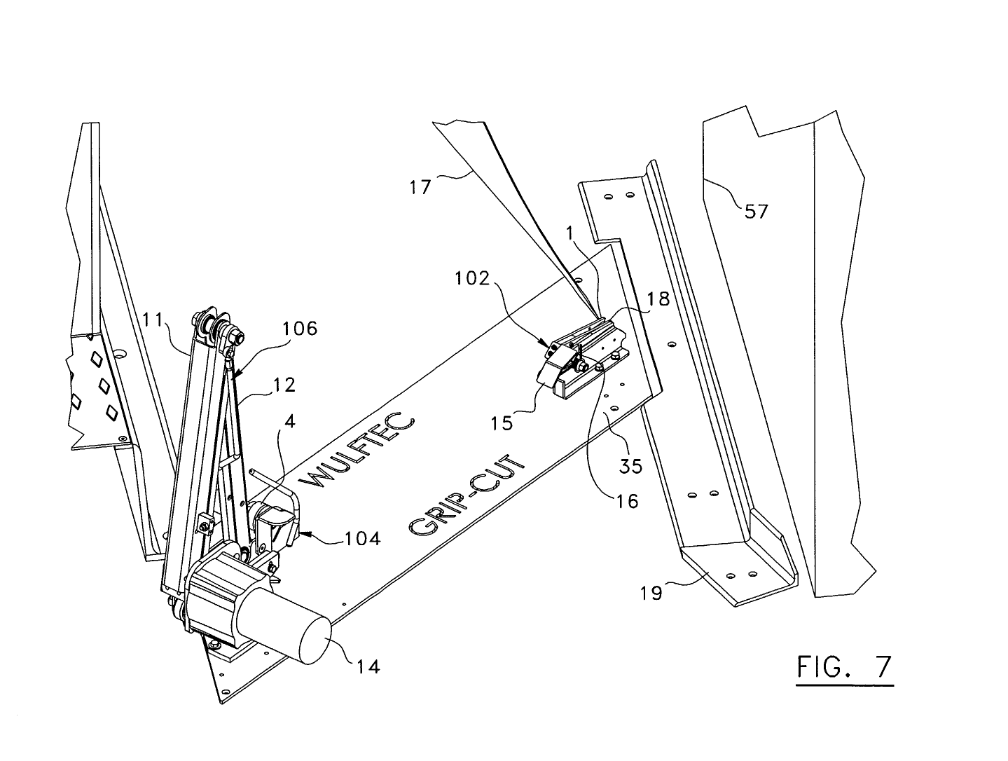

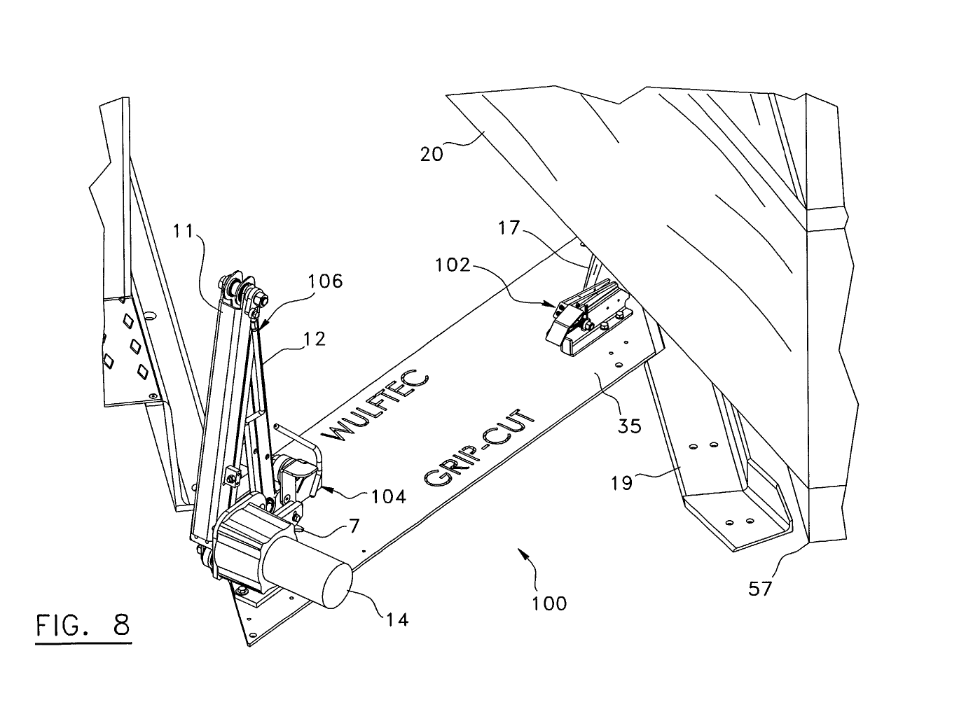

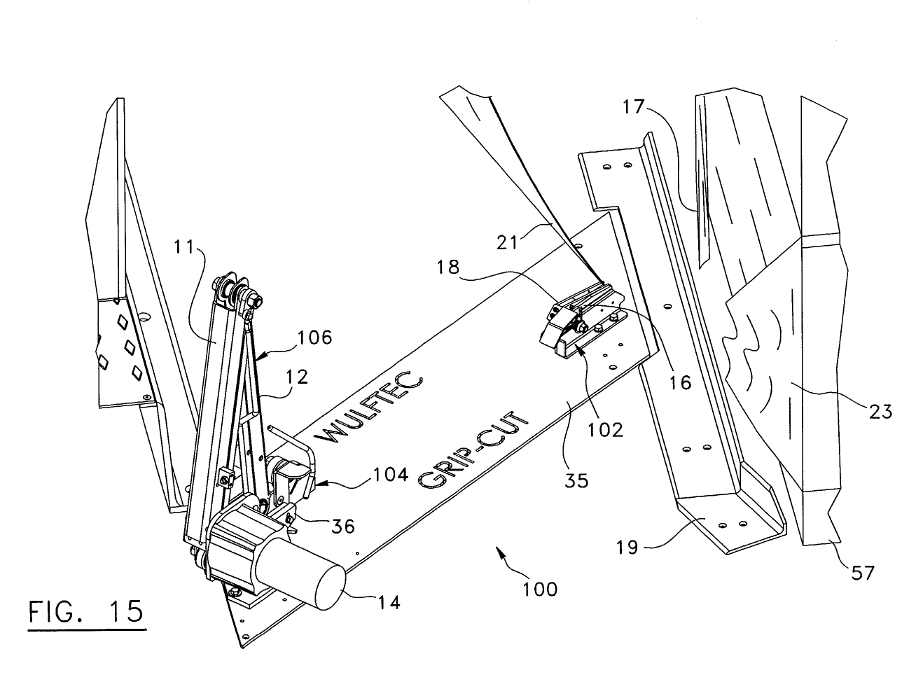

We will now describe with more details the operation of a preferred embodiment of the invention. Referring to FIGS. 6 and 7, at the beginning of a wrapping procedure, a manually roped end portion of flexible material 20 is placed into the jaws 1 and 40 of the clamp 108, thus creating the first film tail 17. The first film tail 17 is entrapped within the upper jaw 1 and the silicone tube 58 mounted in the bottom jaw 40. The coiled spring 16 holds the clamp 108 in the closed position to prevent the tail 17 from slipping out of the jaws 1 and 40. Once the clamp 108 is loaded with the flexible material 20, the load 57 that is placed nearby is ready to be wrapped. In the cases illustrated in FIGS. 3 and 4, the load 57 is placed close to the clamp and cutter assembly 102. In the case illustrated in FIG. 5, the load is placed on the turntable 52c. In any case, the operator then presses start on a button to wrap the load 57. The wrapping cycle is started by rotating the film delivering carriage 55 around the load 57 (according to FIGS. 3 and 4) or by rotating the load 57 (according to FIG. 5). The carriage 55 fully wraps the load 57 with the flexible material 20 by moving the carriage 55 according to a conventional up and down motion. After the conventional wrapping is completed, the rotatable horizontal arm 52 or turntable 52c is stopped at a home position as shown in FIG. 8. The extendable arms 11 and 12 are then moved forward to the active position in order to position the trigger and roper assembly 104 under the flexible material 20 as shown in FIGS. 9 and 11. As shown in FIG. 1, the arm 11 may be provided with a stopper working in combination with a brake pad 36 in order to control its extension. A proximity sensor 61 may also be used for such purpose. The arms 11 and 12 are knuckle jointed by means of a bearing 30 and are provided with linkage bars 13 that are connected together by a linkage bracket 31. As the arms 11 and 12 move forward, as shown consecutively in FIGS. 9, 10A, 10B, and 10C, the trigger 7 forces the jaw 1 of the clamp 108 and the blade 18 of the cutter 110 to open simultaneously as the trigger 7 hits the front extending wheel 3. Of course, those skilled in the art will understand that in case the blade and the cutter are provided with independent trigger mechanisms, it is not necessary that both clamp and cutter open at the same time. At this time, the tail 17 is automatically released and it springs toward the load 57 that was wrapped. Once the arms 11 and 12 are extended in the active position, a portion of the flexible material 20 is guided with the guide 6 in order to be positioned in the grasp of the roping wheels 4 and 5. The proximity sensor 61 then sends a signal to activate the gear motor 24 that rotates the roping wheel 4. The idler wheel 5 is spring loaded against the wheel 4 by a spring 9 through a lever bar 8 (shown in FIG. 2) thus creating a pulling force on the flexible material 20. The portion of the flexible material 20 is then pulled down and is turned into a rope 21 as shown in FIG. 12. Once the rope 21 is formed, the arms 11 and 12 are brought back to their retracted position by activating the gear motor 14. As the arms 11 and 12 move back, the rope 21 is pulled into the open jaws of the clamp 108 and the blades of the cutter 110. After a predetermined travel of the arms 11 and 12, the trigger 7 hits the wheel 3 of the trigger activated mechanism 41, as shown in FIGS. 10D and 10E, thus forcing the movable upper jaw 1 and blade 18 of the clamp and cutter assembly 102 to close on the rope 21. As shown in FIG. 14, the rope 21 is cut as the movable blade 18 is closed on the fixed blade 60, with both acting like scissors. Simultaneously, the motor 24 of the roper is activated in reverse in order to release the gathered rope 21 from the roping and idler wheels 4 and 5. A new film tail 23 springs back to the wrapped product due to internal tension in the tail, as shown in FIGS. 14 and 15. The other portion of rope 21 that is held by the clamp 108 becomes the first tail of the next cycle.

It is worth noting that in case the clamp and the cutter are independent from each other, which means that they do not close simultaneously, then the clamp must be closed first and then the cutter second so as to ensure that the new tail is held and does not spring away if it is ever cut first by the cutter. In case the clamp and cutter are independent, then the cutter may remain open most of the time unlike the clamp which remains closed most of the time, with the cutter being closed only at the appropriate time.

As those skilled in the art will understand, the roper can also have different suitable configurations, such as a conveyor belt type of roper, but the one illustrated is preferred because of its compact size.

Furthermore, it is also to be understood that the moving device 106, which is shown embodied by the two arms 11 and 12, can also have other suitable configurations, such as a piston that pushes and pulls on the trigger and roping assembly. It can also be a motorized wheeled carriage moving back and forth along a track for carrying the trigger and roping assembly. Therefore the word “connected” used to describe the relation between the moving device and the trigger and roping assembly should be construed to mean operationally or temporarily connected and not necessarily permanently connected.

By using the apparatus according to the present invention, the load wrapping process becomes even simpler. Indeed, the operator only has to insert the leading end of the flexible material into the clamp only once. Thereafter, the operators just needs to bring the load, press start and remove the load once it is wrapped.

While embodiments of this invention have been illustrated in the accompanying drawings and described above, it will be evident to those skilled in the art that changes and modifications may be made therein without departing from the essence of this invention. All such modifications or variations are believed to be within the scope of the invention as defined by the claims appended hereto.

1. An apparatus for handling and cutting a flexible material wrapped around a load by means of a delivering device, comprising:
a) a clamp and cutter assembly having:
i) a controllable clamp movable between open and closed positions, the clamp having a trigger activated mechanism for moving the clamp between its open and closed positions, and
ii) a controllable cutter movable between open and closed positions, the cutter having a trigger activated mechanism for moving the cutter between its open and closed positions;
b) a trigger and roping assembly having:
i) a trigger for triggering the trigger activated mechanisms of the controllable clamp and cutter, and
ii) a roper for roping a portion of the flexible material; and
c) a moving device connected to the trigger and roping assembly for moving the trigger and roping assembly between a retracted position and an active position where, as the trigger and roping assembly is moved into its active position, the trigger engages with the trigger activated mechanisms to move the clamp and the cutter to their open position, and the roper engages with a portion of the flexible material extending from the load to the delivering device to turn said portion of flexible material into a rope, and, as the trigger and roping assembly is retracted from its active position, the trigger disengages with the trigger activated mechanisms to move the clamp and the cutter in their closed position, thereby cutting the rope and holding a free end thereof extending from the delivering device by means of the clamp.

2. The apparatus according to claim 1, wherein the clamp has movable and fixed jaws and the cutter has movable and fixed blades, the movable blade being adjacent and solid with the movable jaw, the fixed jaw being adjacent to the fixed blade.

3. The apparatus according to claim 2, wherein the fixed jaw is covered with a silicone tube which cooperates with the movable jaw upon a clamping motion thereof.

4. The apparatus according to claim 2, wherein trigger activated mechanisms of the controllable clamp and cutter are embodied by a single trigger activated mechanism.

5. The apparatus according to claim 4, wherein the single trigger activated mechanism of the controllable clamp and cutter comprises resilient means for urging the clamp and cutter in their closed position.

6. The apparatus according to claim 5, wherein the resilient means comprise a coiled spring mounted on a pivot point of the clamp and cutter assembly.

7. The apparatus according to claim 6, wherein the single trigger activated mechanism comprises a two-legged member pivotally mounted on the pivot point of the clamp and cutter assembly, said two-legged member having front and rear extending legs each provided with a wheel, said two-legged member being biased by the coiled spring, and wherein the trigger comprises rising, flat-top and descending ramps engaging with the wheels of said two-legged member to move the clamp and cutter between the open and closed positions.

8. The apparatus according to claim 7, wherein the roper comprises a drive roping wheel, a motor connected to the drive roping wheel, and an idler wheel facing the drive roping wheel.

9. The apparatus according to claim 8, wherein the trigger and roping assembly comprises a curved guide for guiding the flexible material toward the roper as the trigger and roping assembly moves toward its active position.

10. The apparatus according to claim 1, wherein the moving device comprises a frame, a first arm having a first end pivotally connected to the frame, a second arm having a first end knuckle jointed to a second end of the first arm and a second end having a carrying member provided with wheels for carrying the trigger and roping assembly, and a motor for moving the first and second arms between active and retracted positions.

11. The apparatus according to claim 10, wherein the frame of the moving device and the clamp and cutter assembly are both mounted on a plate at a predetermined distance from each other.

12. The apparatus according to claim 10, wherein the clamp and cutter assembly is mounted on a rotatable turntable of the delivering device.

13. An apparatus for handling and cutting a flexible material wrapped around a load by means of a delivering device, comprising:
a) a clamp and cutter assembly having:
i) a controllable clamp movable between open and closed positions, the clamp having a trigger activated mechanism for moving the: clamp between its open and closed positions, and
ii) a controllable cutter movable between open and closed positions, the cutter having a trigger activated mechanism for moving the cutter between its open and closed positions;
b) a trigger and roping assembly having:
i) a trigger for triggering the trigger activated mechanisms of the controllable clamp and cutter, and
ii) a roper for roping a portion of the flexible material; and
c) a moving device connected to the trigger and roping assembly for moving the trigger and roping assembly between a retracted position and an active position where, as the trigger and roping assembly is moved into its active position, the trigger engages with the trigger activated mechanisms to move the clamp and the cutter to their open position, and the roper engages with a portion of the flexible material extending from the load to the delivering device to turn said portion of flexible material into a rope, and, as the trigger and roping assembly is retracted from its active position, the trigger disengages with the trigger activated mechanisms to move the clamp and the cutter in their closed position, thereby cutting the rope and holding a free end thereof extending from the delivering device by means of the clamp;
wherein the clamp has movable and fixed jaws and the cutter has movable and fixed blades, the movable blade being adjacent and solid with the movable jaw, the fixed jaw being adjacent to the fixed blade, and wherein the moving device comprises a frame, a first arm having a first end pivotally connected to the frame, a second arm having a first end knuckle jointed to a second end of the first arm and a second end for carrying the trigger and roping assembly, and a motor for moving the first and second arms between active and retracted positions.

14. A method for handling and cutting a flexible material wrapped around a load by means of a delivering device, comprising the steps of:
a) moving a trigger and roping assembly from a retracted position to an active position;
b) engaging a trigger of the trigger and roping assembly with a trigger activated means of a clamp and cutter assembly as the trigger and roping assembly is moved into its active position;
c) moving the clamp and the cutter assembly from a closed position to an open position in response to the trigger engaging the trigger activated means;
d) engaging a roper of the trigger and roping assembly with a portion of the flexible material extending from the load to the delivering device to turn said portion of flexible material into a rope, as the trigger and roping assembly is moved into its active position;
e) moving the trigger and roping assembly from the active position to the retracted position;
f) disengaging the trigger from the trigger activated means as the trigger and roping assembly is retracted from its active position; and
g) moving the clamp and cutter assembly from the open position to the closed position in response to the trigger disengaging from the trigger activated means, thereby cutting the rope and holding a free end thereof extending from the delivering device by means of the clamp and cutter assembly.

15. The method according to claim 14, wherein the clamp and cutter assembly comprises movable and fixed jaws and movable and fixed blades, the movable blade being adjacent and solid with the movable jaw, the fixed jaw being adjacent to the fixed blade.

16. The method according to claim 15, wherein the fixed jaw is covered with a silicone tube which cooperates with the movable jaw upon a clamping motion thereof.

17. The method according to claim 15, wherein trigger activated means of the clamp and cutter assembly are embodied by a single trigger activated mechanism.

18. The method according to claim 17, wherein the single trigger activated mechanism of the clamp and cutter assembly comprises a coiled spring mounted on a pivot point of the clamp and cutter assembly.

19. The method according to claim 18, wherein the single trigger activated mechanism comprises a two-legged member pivotally mounted on the pivot point of the clamp and cutter assembly, said two-legged member having front and rear extending legs each provided with a wheel, said two-legged member being biased by the coiled spring, and wherein the trigger comprises rising, flat-top and descending ramps engaging with the wheels of said two-legged member to move the clamp and cutter between the open and closed positions.

20. The method according to claim 14, wherein said steps a) and e) are performed by means of a moving device comprising a frame, a first arm having a first end pivotally connected to the frame, a second arm having a first end knuckle jointed to a second end of the first arm and a second end for carrying the trigger and roping assembly, and a motor for moving the first and second arms between active and retracted positions.

21. The method according to claim 20, wherein the frame of the moving device and the clamp and cutter assembly are both mounted on a plate at a predetermined distance from each other.

22. The apparatus according to claim 20, wherein the clamp and cutter assembly is mounted on a rotatable turntable of the delivering device.
